(19) United States
(12) Patent Application Publication
(10) Pub. No.: US 2018/0299727 A1
(43) Pub. Date: Oct. 18, 2018

(54) DISPLAY DEVICES

(71) Applicant: Shenzhen China Star Optoelectronics Technology Co. Ltd., Shenzhen, Guangdong (CN)

(72) Inventor: Yong FAN, Shenzhen, Guangdong (CN)

(73) Assignee: Shenzhen China Star Optoelectronics Technology Co., Ltd., Shenzhen, Guangdong (CN)

(21) Appl. No.: 15/520,388

(22) PCT Filed: Apr. 13, 2017
(86) PCT No.: PCT/CN2017/080412

§ 371 Date: Apr. 19, 2017

(30) Foreign Application Priority Data
Mar. 14, 2017 (CN) 201710149678.X

(51) Int. Cl. G02F 1/1335

(52) U.S. Cl. CPC G02F 1/133555; G02F 1/133617; G02F 2001/133562; G02F 2201/17; G02F 2201/501; G02F 2202/108; G02F 2202/106; G02F 2203/055

(57) ABSTRACT

The present disclosure relates to a display device includes a display panel and a backlight source. The display panel includes a top substrate and a down substrate opposite to the top substrate. The top substrate includes a reflective filter layer and a colorful luminous layer. The colorful luminous layer respectively emit red, green, and blue light beams emitting out from the reflective filter layer. The reflective filter layer reflects a portion of the light beams from the backlight source to the reflective filter layer into the colorful luminous layer to further activate the colorful luminous layer to emit the light beams to enhance an optical performance. In this way, the content of the QDs of the colorful luminous layer can be reduced without affecting the luminous effect such that the concentration of the cadmium element may comply to the requirement of the ROHS standard

### BACKGROUND OF THE INVENTION

### 1. Field of the Invention

The present disclosure relates to display technology, and more particularly to a display device.

### 2. Discussion of the Related Art

Quantum dots (QDs) have been used in displays to improve the display color gamut of the display due to their adjustable emission spectrum and high luminous efficiency. QDs can be divided into cadmium-containing QDs and cadmium-free QDs, and cadmium-containing QDs are more effective than the non-cadmium-containing QDs. Also, the emission spectra of the cadmium-containing QDs are narrower than that of the cadmium-free QDs, and thus cadmium QDs are more effective when being adopted in displays.

However, since the cadmium element is the element being limited in regard to the concentration in the “Directive on the Use of Certain Hazardous Ingredients in Electrical and Electronic Equipment” (ROHS) standards, and thus when the cadmium-containing QD is selected for use in a display, it is necessary to reduce the content of cadmium in the QDs without affecting the display performance of the display.

### SUMMARY

The present disclosure relates to a thin film transistor (TFT) and the manufacturing method thereof to reduce the QD content without affecting the luminous effect.

In one aspect, a display device includes: a display panel and a backlight source; wherein the display panel includes a top substrate and a down substrate opposite to the top substrate, the top substrate includes a reflective filter layer and a colorful luminous layer stacked along a top-down direction, and the colorful luminous layer includes a red quantum dot (QD) area, a green QD area, and a blue QD area, the backlight source is arranged below the down substrate to provide light beams to the colorful luminous layer, such that the colorful luminous layer respectively emit red, green, and blue light beams emitting out from the reflective filter layer, the reflective filter layer reflects a portion of the light beams from the backlight source to the reflective filter layer into the colorful luminous layer to further activate the colorful luminous layer to emit the light beams to enhance an optical performance; the reflective filter layer is configured to reflect the light beams having a reflective waveform less than or equal to a predetermined wavelength, and is configured to reflect the light beams having a transmission wavelength greater than the predetermined wavelength; a protection layer is arranged on the reflective filter layer, and the protection layer is configured to prevent the colorful luminous layer from being eroded.

In another aspect, a display device includes: a display panel and a backlight source; wherein the display panel includes a top substrate and a down substrate opposite to the top substrate, the top substrate includes a reflective filter layer and a colorful luminous layer stacked along a top-down direction, and the colorful luminous layer includes a red quantum dot (QD) area, a green QD area, and a blue QD area, the backlight source is arranged below the down substrate to provide light beams to the colorful luminous layer, such that the colorful luminous layer respectively emit red, green, and blue light beams emitting out from the reflective filter layer, the reflective filter layer reflects a portion of the light beams from the backlight source to the reflective filter layer into the colorful luminous layer to further activate the colorful luminous layer to emit the light beams to enhance an optical performance.

In view of the above, by configuring a reflective filter layer on the colorful luminous layer 112 of the red QD area, the green QD area, and the blue QD area, the light beams from the colorful luminous layer 112 may pass through the reflective filter layer 111. A portion of the light beams from the backlight source is reflected on the colorful luminous layer 112 to further activate the colorful luminous layer 112. In this way, the optical utilization rate of the backlight source and the luminous efficiency of the colorful luminous layer 112 are enhanced. Also, the content of the QDs of the colorful luminous layer 112 can be reduced without affecting the luminous effect such that the concentration of the cadmium element may comply to the requirement of the ROHS standard.

### BRIEF DESCRIPTION OF THE DRAWINGS

Embodiments of the invention will now be described more fully hereinafter with reference to the accompanying drawings, in which the technical advantages of the embodiments of the invention are shown.

FIG. 1 is a schematic view of the display in accordance with one embodiment of the present disclosure.

FIG. 2 is a schematic view of the reflective filter layer in FIG. 1.

### DETAILED DESCRIPTION OF THE EMBODIMENTS

Embodiments of the invention will now be described more fully hereinafter with reference to the accompanying drawings, in which embodiments of the invention are shown.

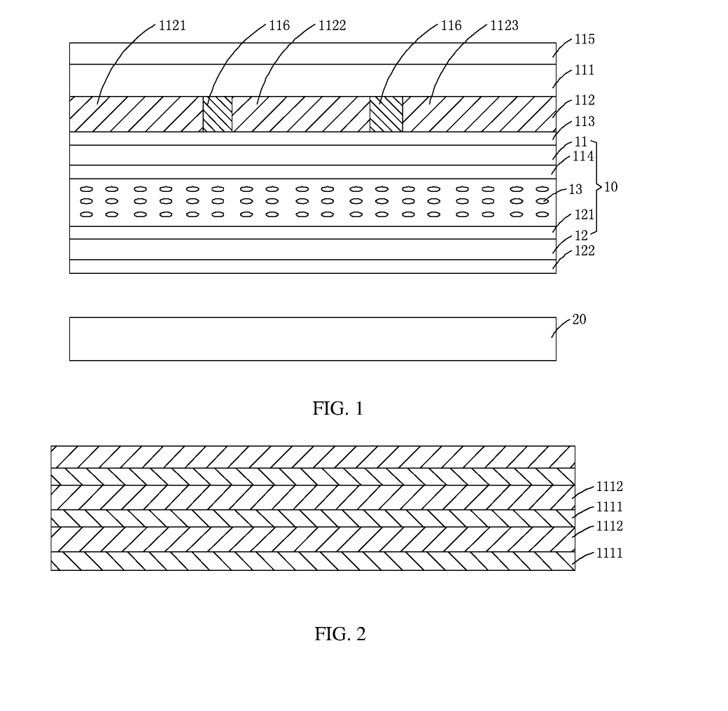

Referring to FIG. 1, the display device includes a display panel 10 and a backlight source 20.

The display panel 10 includes a top substrate 11 and a down substrate 12 opposite to the top substrate 11.

In an example, the top substrate 11 and the down substrate 12 are glass substrates.

The top substrate 11 includes a reflective filter layer 111 and a colorful luminous layer 112 stacked along a direction from top to down. A top polarizer 113 is arranged between the colorful luminous layer 112 and the top substrate 11, and a top electrode is further arranged below the top substrate 11.

The reflective filter layer 111 is configured to reflect light beams having a reflective waveform less than or equal to a predetermined wavelength, and is configured to reflect the light beams having a transmission wavelength greater than the predetermined wavelength.

Referring to FIG. 2, the reflective filter layer 111 adopts an optical thin film structure having a high reflective layer 1111 and a low reflective layer 1112. The high reflective layer 1111 and the low reflective layer 1112 are stacked in an alternated sequence.

In an example, the predetermined wavelength is in a range from 400 nm to 430 nm.

A thickness of the high reflective layer 1111 is H=h/λ 1, and the thickness of the low reflective layer 1112 is L=h/λ 2, wherein λ 1 relates to a reflective rate of the high reflective layer 1111, λ 2 is a reflective rate of the low reflective layer 1112, h is an optical thickness of the high reflective layer 1111 and/or the low reflective layer 1112, and the optical thickness is a quarter of the wavelength of visible light beams.

In an example, the high reflective layer 1111 is made by polyethylene naphthalate (PEN), the low refractive layer 1112 is made by polymethyl methacrylate (PMMA), and the wavelength of the visible light beam is 552 nm. The number of layers of the reflective filter layer 111 may be determined depending on the actual situation.

The colorful luminous layer 112 includes a red QD area 1121, a green QD area 1122, and a blue QD area 1123. The red QD area 1121, the green QD area 1122, and the blue QD area 1123 may emit red light beams, green light beams, blue light beams when being activated by light beams provided by the backlight source 20.

The wavelength of the red light beams emitted by the red QD area 1121 is in a range from 620 nm to 760 nm, the wavelength of the green light beams emitted by the green QD area 1122 is in a range from 500 nm to 530 nm, and the wavelength of the blue light beams emitted by the blue QD area 1123 is in a range from 430 nm to 470 nm.

The QDs in the red QD area 1121, the green QD area 1122, and the blue QD area 1123 are quantum dopant material, such as cadmium selenide or cadmium sulfide.

A down electrode 121 is arranged above the down substrate 12, and a down polarizer 122 is arranged below the down substrate 12. A liquid crystal 13 is arranged between the down substrate 12 and the top substrate 11.

The backlight source 20 is arranged below the down substrate 12 to provide the light beams for the colorful luminous layer 112 such that the colorful luminous layer 112 is activated to emit the light beams.

As an excitation efficiency of the light beams having a greater wavelength is smaller than that of the light beams having a shorter wavelength, in one embodiment, the backlight 20 is an ultraviolet (UV) light source and a short-wave blue light source.

The wavelength of the light beams from the UV light source is in a range from 360 nm to 400 nm, and the wavelength of the short-wave blue light source is in a range from 375 nm to 430 nm

Further, a protection layer 115 is arranged on the reflective filter layer 111. The protection layer 115 is configured to protect the QDs within the colorful luminous layer 112 not being eroding by external substances, such as water or oxygen.

In an example, the protective layer is made by ethylene terephthalate (PET).

Black matrices 116 are arranged on the top substrate 11. The black matrix 116 is arranged between the red QD area 1121, the green QD area 1122, and the blue QD area 1123. In other embodiments, the black matrix 116 may be arranged above the down substrate 12, or may be arranged above the top substrate 11 and the down substrate 12.

Further referring to FIG. 1, the backlight source 20 provides the light beams to the colorful luminous layer 112. By adopting the UV light source or the short-wave blue light source, the excitation efficiency of the QDs in the colorful luminous layer 112 is increased. When the colorful luminous layer 112 is activated to respectively emit the red, the green, and the blue light beams, the red, the green, and the blue light beams may pass through the reflective filter layer 111 on the colorful luminous layer 112 for the reason that the wavelengths of the red, the green, and the blue light beams are greater than the predetermined wavelength of the reflective filter layer 111. At this moment, the light beams provided by the backlight source 20 pass through the colorful luminous layer 112 and are reflected on the reflective filter layer 111. A portion of the light beams provided by the backlight source 20 are reflected on the colorful luminous layer 112 for the reason that the wavelength of the light beams are smaller than the predetermined wavelength, and the reflected light beams further activate the colorful luminous layer 112 to respectively emit the red, the green, and the blue light beams. In this way, the light source utilization may be enhanced.

The colorful luminous layer 112 is further activated by the colorful luminous layer 112 to increase the luminous efficiency of the colorful luminous layer 112, and the content of the QDs of the colorful luminous layer 112 can be reduced without affecting the luminous effect. At the same time, since the UV rays and the short-wave blue light beams are partially reflected to the colorful luminous layer 112, the transmitted UV rays and the short-wave blue light beams are reduced, thereby protecting the viewer's eyes.

In view of the above, by configuring a reflective filter layer on the colorful luminous layer 112 of the red QD area, the green QD area, and the blue QD area, the light beams from the colorful luminous layer 112 may pass through the reflective filter layer 111. A portion of the light beams from the backlight source is reflected on the colorful luminous layer 112 to further activate the colorful luminous layer 112. In this way, the optical utilization rate of the backlight source and the luminous efficiency of the colorful luminous layer 112 are enhanced. Also, the content of the QDs of the colorful luminous layer 112 can be reduced without affecting the luminous effect such that the concentration of the cadmium element may comply to the requirement of the ROHS standard.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A display device, comprising:
a display panel and a backlight source;
wherein the display panel comprises a top substrate and a down substrate opposite to the top substrate, the top substrate comprises a reflective filter layer and a colorful luminous layer stacked along a top-down direction, and the colorful luminous layer comprises a red quantum dot (QD) area, a green QD area, and a blue QD area, the backlight source is arranged below the down substrate to provide light beams to the colorful luminous layer, such that the colorful luminous layer respectively emit red, green, and blue light beams emitting out from the reflective filter layer, the reflective filter layer reflects a portion of the light beams from the backlight source to the reflective filter layer into the colorful luminous layer to further activate the colorful luminous layer to emit the light beams to enhance an optical performance;
the reflective filter layer is configured to reflect the light beams having a reflective waveform less than or equal to a predetermined wavelength, and is configured to reflect the light beams having a transmission wavelength greater than the predetermined wavelength;
a protection layer is arranged on the reflective filter layer, and the protection layer is configured to prevent the colorful luminous layer from being eroded.

2. The device as claimed in claim 1, wherein the predetermined wavelength is in a range from 400 nm to 430 nm

3. The device as claimed in claim 2, wherein the wavelength of the red light beams emitted by the red QD area is in a range from 620 nm to 760 nm, the wavelength of the green light beams emitted by the green QD area is in a range from 500 nm to 530 nm, and the wavelength of the blue light beams emitted by the blue QD area is in a range from 430 nm to 470 nm, and the wavelength emitted by the backlight source is in a range from 360 nm to 430 nm

4. The device as claimed in claim 3, wherein the backlight source is an UV light source or a short-wave blue light source.

5. The device as claimed in claim 4, wherein the wavelength of the light beams from the UV light source is in a range from 360 nm to 400 nm, and the wavelength of the short-wave blue light source is in a range from 375 nm to 430 nm.

6. The device as claimed in claim 1, wherein the reflective filter layer comprises a high reflective layer and a low reflective layer, and the high reflective layer and the low reflective layer are stacked in an alternated sequence.

7. The device as claimed in claim 6, wherein a thickness of the high reflective layer is H=h/λ 1, and the thickness of the low reflective layer is L=h/λ 2, wherein λ 1 relates to a reflective rate of the high reflective layer, λ 2 is a reflective rate of the low reflective layer, h is an optical thickness of the high reflective layer and/or the low reflective layer, and an optical thickness is a quarter of the wavelength of visible light beams.

8. The device as claimed in claim 1, wherein black matrices are arranged on the top substrate, and the black matrix is arranged between the red QD area, the green QD area, and the blue QD area.

9. A display device, comprising:
a display panel and a backlight source;
wherein the display panel comprises a top substrate and a down substrate opposite to the top substrate, the top substrate comprises a reflective filter layer and a colorful luminous layer stacked along a top-down direction, and the colorful luminous layer comprises a red quantum dot (QD) area, a green QD area, and a blue QD area, the backlight source is arranged below the down substrate to provide light beams to the colorful luminous layer, such that the colorful luminous layer respectively emit red, green, and blue light beams emitting out from the reflective filter layer, the reflective filter layer reflects a portion of the light beams from the backlight source to the reflective filter layer into the colorful luminous layer to further activate the colorful luminous layer to emit the light beams to enhance an optical performance.

10. The device as claimed in claim 9, wherein the reflective filter layer is configured to reflect the light beams having a reflective waveform less than or equal to a predetermined wavelength, and is configured to reflect the light beams having a transmission wavelength greater than the predetermined wavelength.

11. The device as claimed in claim 10, wherein the predetermined wavelength is in a range from 400 nm to 430 nm.

12. The device as claimed in claim 11, wherein the wavelength of the red light beams emitted by the red QD area is in a range from 620 nm to 760 nm, the wavelength of the green light beams emitted by the green QD area is in a range from 500 nm to 530 nm, and the wavelength of the blue light beams emitted by the blue QD area is in a range from 430 nm to 470 nm, and the wavelength emitted by the backlight source is in a range from 360 nm to 430 nm.

13. The device as claimed in claim 12, wherein the backlight source is an UV light source or a short-wave blue light source.

14. The device as claimed in claim 13, wherein the wavelength of the light beams from the UV light source is in a range from 360 nm to 400 nm, and the wavelength of the short-wave blue light source is in a range from 375 nm to 430 nm.

15. The device as claimed in claim 10, wherein the reflective filter layer comprises a high reflective layer and a low reflective layer, and the high reflective layer and the low reflective layer are stacked in an alternated sequence.

16. The device as claimed in claim 15, wherein a thickness of the high reflective layer is H=h/λ 1, and the thickness of the low reflective layer is L=h/λ 2, wherein λ 1 relates to a reflective rate of the high reflective layer, λ 2 is a reflective rate of the low reflective layer, h is an optical thickness of the high reflective layer and/or the low reflective layer, and an optical thickness is a quarter of the wavelength of visible light beams.

17. The device as claimed in claim 9, wherein a protection layer is arranged on the reflective filter layer, and the protection layer is configured to prevent the colorful luminous layer from being eroded.

18. The device as claimed in claim 9, wherein black matrices are arranged on the top substrate, and the black matrix is arranged between the red QD area, the green QD area, and the blue QD area.
